(19) United States
(12) Patent Application Publication
(10) Pub. No.: US 2007/0283238 A1
(43) Pub. Date: Dec. 6, 2007

(54) Multi-layer interactive multimedia presentation

(76) Inventors: Marlen Hecht, New York, NY (US); Dean Silvers, New York, NY (US)

Correspondence Address: BINGHAM MCCUTCHEN LLP, 2020 K Street, N.W., Intellectual Property Department, WASHINGTON, DC, 20006, US

(21) Appl. No.: 11/442,527

(22) Filed: May 30, 2006

(51) Int. Cl. G06F 17/00

(52) U.S. Cl. 715/501.1

(57) ABSTRACT

A method and apparatus by which information of similar or different types may be combined to form an integrated interactive multimedia presentation which may be used to provide marketing and conducting commerce is provided. An apparatus for providing a multi-layer interactive multimedia presentation comprises means for providing a layer of program presentation, including a plurality of link indicators, means for providing at least one additional layer of program presentation, including a plurality of link indicators, and means for providing at least one display of informational or promotional content, or means for providing at least one display of commerce/purchasing content, or any combination thereof, wherein each link indicator is operable to cause display of either an additional layer of program presentation, a display of informational or promotional content, or a display of commerce/purchasing content. The display of the layer of program information, the additional layers of program presentation, the display of informational or promotional content, and the display of commerce/purchasing content may be used to direct a user toward additional informational or promotional content or toward performing a commerce/purchasing transaction.

### BACKGROUND OF THE INVENTION

1. Field of the Invention

The present invention relates to providing a multi-layer interactive multimedia presentation.

2. Description of the Related Art

The “revolution” in the new media environment has altered the delivery and packaging of content as well as the traditional methods of marketing, advertising, and selling. The explosion in technology has multiplied the channels of distribution to consumers as well. In the past, companies primarily marketed and sold their products and brands through traditional channels: network TV, magazines, billboards, and direct mail. Consumers are now barraged by multiple new options of advertising and marketing: cable, the Internet, and specialty magazines are just a few. This proliferation and fragmentation of media leaves companies desperately searching for the most effective way to reach their customers.

One medium in use is the Digital Video (or Versatile) Disk (DVD). The DVD is capable of data storage, including movies with high video and sound quality, games, photos, computer data, etc. Typically, DVDs allow integration of different types of data into the same presentation, but this capability has generally not been greatly utilized. For example, a traditional DVD may include one or more movies or other videos, as well as other types of information that are accessed from one or more menus. There is no linkage between the content of the videos and the other information. This makes it difficult for a user to obtain information directly or indirectly relating to particular content in the videos. A need arises for a technique by which information of similar or different types may be combined to form an integrated interactive multimedia presentation.

### SUMMARY OF THE INVENTION

The present invention provides a technique by which information of similar or different types may be combined to form an integrated interactive multimedia presentation. The presentation includes a layer of program content, such as a main entertainment program, which captures the user's attention. Link indicators throughout the program indicate additional layers of content to which the user may “Drill Down” or “Click and Connect”. The additional layers of content may include additional layer program content, to which the user may “Drill Down”, or the additional layer of content may include informational or promotional content, such as Web pages, search results, etc.

In one embodiment of the present invention, apparatus for providing a multi-layer multimedia presentation comprises means for providing a layer of program presentation, the layer of program presentation including a plurality of link indicators, means for providing at least one additional layer of program presentation, each additional layer of program presentation including a plurality of link indicators, and means for providing at least one display of informational or promotional content, or means for providing at least one display of commerce/purchasing content, or any combination thereof, wherein each link indicator is operable to cause display of either an additional layer of program presentation, a display of informational or promotional content, or a display of commerce/purchasing content.

In one aspect of the present invention, an additional layer of program presentation that is displayed upon operation of a link indicator may include subject matter directly or indirectly related to subject matter of the layer of program presentation that includes the link indicator. Informational or promotional content that is displayed upon operation of a link indicator may include subject matter directly or indirectly related to subject matter of the layer of program presentation that includes the link indicator.

In one aspect of the present invention, the apparatus may further comprise means for, upon operation of a link indicator, transmitting a request for information and receiving informational or promotional content to be displayed.

In one aspect of the present invention, commerce/purchasing content that is displayed upon operation of a link indicator includes subject matter directly or indirectly related to subject matter of the layer of program presentation or informational or promotional content that includes the link indicator. The apparatus may further comprise means for, upon operation of a link indicator, transmitting a request for information and receiving commerce/purchasing content to be displayed. The informational or promotional content, the commerce/purchasing content, or both, may be obtained using a customized resource library or guide, including information that has been customized to focus a user on selected informational or promotional content or a selected commerce or purchasing transaction.

In one aspect of the present invention, the layer of program presentation and at least some of the plurality of additional layers of program presentation may be stored on a computer readable storage medium possessed by a user of the apparatus. The informational or promotional content and the commerce/purchasing content may be obtained over the Internet or Web. The computer readable storage medium may be a DVD.

In one aspect of the present invention, the layer of program presentation, the plurality of additional layers of program presentation, the informational or promotional content, and the commerce/purchasing content may be obtained over the Internet or Web. At least a portion of the link indicators may be customized to relate to the subject matter of a program presentation in which each link indicator is included.

In an embodiment of the present invention, a method of providing marketing and conducting commerce comprises providing a layer of program presentation relating to a general topic, the layer of program presentation including a plurality of link indicators, each link indicator relating to a segment of the layer of program presentation, providing at least one additional layer of program presentation, each additional layer of program presentation including a plurality of link indicators, each additional layer of program presentation providing additional information directly or indirectly relating to a segment of the layer of program presentation or another additional layer of program presentation that includes a link indicator that causes display of the additional layer of program presentation, and providing at least one display of informational or promotional content or at least one display of commerce/purchasing content each display of informational or promotional content or of commerce/purchasing content directly or indirectly relating to a segment of the layer of program presentation, an additional layer of program presentation, or another display of informational or promotional content or commerce/purchasing content that includes a link indicator that causes display of the informational or promotional content or the commerce/purchasing content, wherein the display of the layer of program information, the additional layers of program presentation, the display of informational or promotional content, and the display of commerce/purchasing content direct a user toward additional informational or promotional content or toward performing a commerce/purchasing transaction.

In one aspect of the present invention, apparatus may comprise, or the method may be performed using, a DVD player, a network-connected DVD player, a personal computer, a network-connected personal computer, a personal computer with a television receiver/monitor, a personal computer with a high-definition television receiver/monitor, a network-connected personal computer with a television receiver/monitor, a network-connected personal computer with a high-definition television receiver/monitor, a convergence device, an interactive display device, a multimedia telephone, an interactive television, or any combination thereof.

### BRIEF DESCRIPTION OF THE DRAWINGS

Further features and advantages of the invention can be ascertained from the following detailed description that is provided in connection with the drawings described below:

FIG. 1 is an exemplary diagram of an integrated multi-layer interactive multimedia presentation, according to the present invention.

FIG. 2 is exemplary block diagram of a system in which the present invention may be implemented.

FIG. 3 is an exemplary screen of a menu.

FIG. 4 is an exemplary screen of a video segment in a layer.

FIG. 5 is an exemplary screen of a video segment in an additional layer.

FIG. 6 is an exemplary screen of a video segment in an additional layer.

FIG. 7 is an exemplary screen of a video segment an additional layer.

FIG. 8 is an example of display of informational or promotional content.

FIG. 9 is an example of display of commerce/purchasing content.

FIG. 10 is an exemplary block diagram of a server system in which the present invention may be implemented.

### DETAILED DESCRIPTION OF THE PREFERRED EMBODIMENTS

The present invention provides a technique and apparatus by which information of similar or different types may be combined to form an integrated interactive multimedia presentation. The presentation includes a layer of program content, such as a main entertainment program, which captures the user's attention. Link indicators throughout the program indicate additional layers of content to which the user may “Drill Down” or “Click and Connect”. The additional layers of content may include additional layers of program content, to which the user may “Drill Down”, or the additional layer of content may include informational or promotional content, such as Web pages, search results, etc. Eventually, the user may be directed to commerce/purchasing content, which provides the capability for the user to actually purchase items or products directly or indirectly related to the informational or promotional content.

For example, a layer of program content may relate generally to a topic of interest to a user. The layer of program content will present a number of segments of more specific information that may be directly or indirectly related to the topic of the layer. During each segment, one or more link indicators are displayed, which indicates that additional information directly or indirectly related to the subject matter of the segment is available. Such additional information may be directly related to the subject matter of the segment. For example, information may be provided that includes more details about the subject matter of the segment or that expands the information (or includes resources of information), and that provides the viewer with “choices”—the viewer has the freedom to select or not to select additional layer(s) of information. Examples of such choices may include information about how to do what is described in the segment, information about related topics, information about a person or persons, or historical people, involved with the subject matter, customized resource guide, search engine about the subject matter, information about the location of the subject matter, etc. The information may be less directly related or indirectly related to the subject matter. For example, information may be provided that includes topics that are less related or only slightly related to the subject matter of the segment. Even information that is completely unrelated to the subject matter of the segment may be included, but, typically, the included information bears at least some slight relation to the subject matter of the segment. The present invention contemplates the inclusion of any type of subject matter, whether directly related, indirectly related, or unrelated to the subject matter of the segment.

Selection of a link indicator causes display of the additional information in the form of additional layers of content. These additional layers of content may be additional program content, informational or promotional content, or commerce/purchasing content.

As the user follows their interests by selecting particular link indicators, typically, at first additional program content layers are presented. The program content layers are designed to encourage the user to obtain additional information on their interests by drilling down to additional layers of content. As the user drills down into the presentation, at some point layers of informational or promotional content, which, for example, may be obtained dynamically over a communications network connection, is presented. The informational or promotional content is obtained by a special search engine or scout, which is designed to focus the user's interest on particular information directly or indirectly relating to their interests. This focusing eventually may lead to the presentation of commerce/purchasing content, which provides the capability for the user to purchase items or products directly or indirectly relating to their interests. These items and products are likewise selected by the special search engine or scout, based on criteria defined by the operator of the search engine.

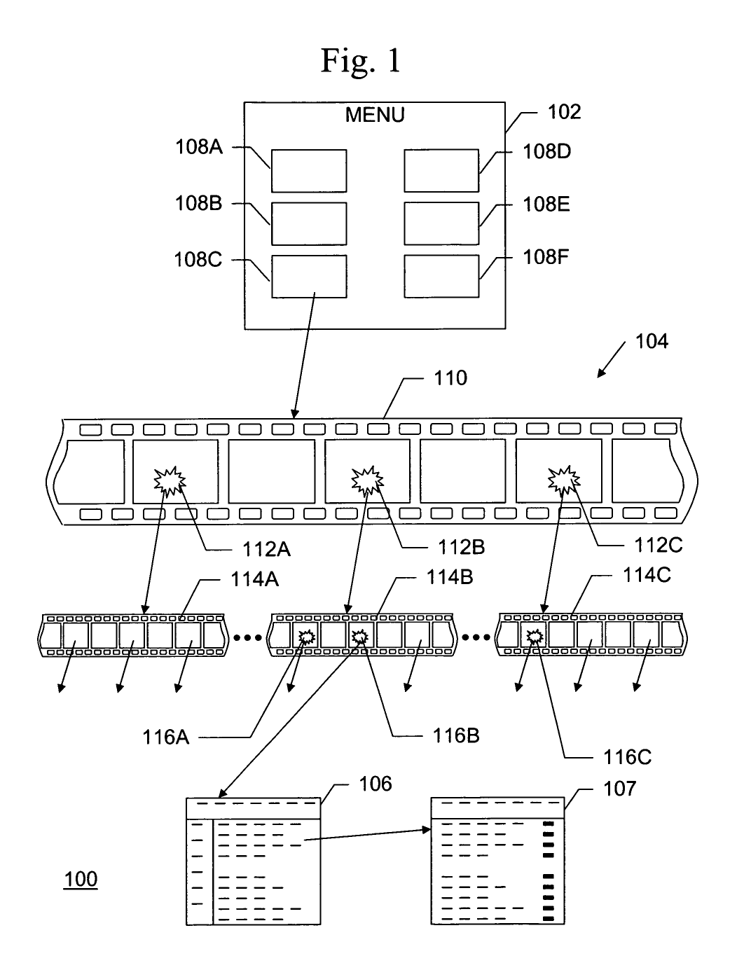

An example of an integrated multi-layer interactive multimedia presentation 100, according to the present invention, is shown in FIG. 1. In this example, presentation 100 includes one or more menus 102, at least two layers of program content 104, at least one layer of informational or promotional content 106 and at least one purchasing, or commerce layer 107. Menu 102 includes a plurality of selections, such as selections 108A-F. Some selections may link to one or more levels of submenu (not shown), but some selections, such as selection 108C, may link to program content 104.

Typically, a menu selection, such as selection 108C, will link to a layer of program content 104, such as layer 110. Typically, layer 110 is a main entertainment or informational or promotional program on a particular topic. The format of layer 110 may be any format that can be programmatically presented, such as audio programs, video programs, audiovisual programs, graphical programs, animated programs, etc. The range of topics that may be presented is essentially unlimited. For example, the topics may include entertainment topics, informational or promotional topics, educational topics, etc. For example, the programs may include movies, television shows, plays, lectures, documentaries, visual and audio media, slides shows, how-to, do-it-yourself or other demonstrations, accompaniments to textbooks, guides, guidebooks, catalogs, etc., or combinations of these and other types of topics.

Throughout layer 110, link indicators, such as link indicators 112A-C may appear. Link indicators 112A-C provide links to additional layers of program content, such as layers 114A-C, or to informational or promotional content layer 106. In the program content of layer 110, each scene or informational point, or selected scenes or informational points may have a link indicator inserted. For example, at a particular scene or point in layer 110, link indicator 112B has been inserted. When the user selects link indicator 112B, such as by clicking on the link indicator using a pointing device, input device, or any device that allows selection of a link indicator, the presentation shifts and a new selection of program content, such as layer 114B, is displayed to the user. It is to be noted that, the user may be provided with the capability to at any time return to the original presentation and resume viewing at approximately the same point at which the link indicator was selected.

Typically, the newly selected program content relates to the content of the scene or informational point at which the link indicator was inserted. For example, if layer 110 includes an informational or promotional topic, such as a how-to presentation, a link indicator may be inserted at each step or at selected steps in the process being explained by the how-to presentation. If a user selects a particular link indicator, such as link indicator 112B, layer 114B is then displayed to the user. In this example, the content of newly selected layer 114B will provide additional details about the step into which link indicator 112B is inserted.

Additional layers of program content, such as layers 114A-C may also include link indicators, such as link indicators 116A-C. Link indicators 116A-C provide links to additional layers of program content, or to informational or promotional content layer 106. For example, presentation 100 includes a main layer 110 of program content and at least one additional layer 114A-C of program content. However, presentation 100 may include as many additional layers of program content as desired, in any arrangement desired. For example, some link indicators in a particular layer, such as link indicator 116B, may link to informational or promotional content layer 106, while other link indicators in the same layer, such as link indicator 116A, or in different layers, such as link indicator 116C, may link to other layers of program content.

Informational or promotional content layer 106 typically includes at least some information that is not displayed in a program format, although some information in a program format may be presented. Typically, the information displayed by informational or promotional content layer 106 includes details directly or indirectly relating to the scene or informational point in the program content layer at which the link indicator that linked to the informational or promotional content layer 106 was inserted. For example, if layer 110 includes an informational or promotional topic, such as a how-to presentation, a link indicator may be inserted at each step or at selected steps in the process being explained by the how-to presentation. The content of newly selected layer 114B will provide additional details about the step into which link indicator 112B is inserted. Link indicator 116B is inserted at a particular point or sub-step presented in layer 114B and informational or promotional content layer 106 will provide additional details directly or indirectly relating to that point or sub-step, such as sources of supply for the tools and materials that are used to perform the related sub-step.

It is to be noted that, for simplicity, only one exemplary informational or promotional content layer 106 is shown in FIG. 1. However, the present invention contemplates that any number of informational or promotional content layers may be included in presentation 100.

Informational or promotional content layer 106 may be predefined and pre-recorded, but, informational or promotional content layer 106 may include dynamically generated information that is obtained using a communications link. In this arrangement, when the user selects a link indicator that links to informational or promotional content layer 106, a request for information is transmitted over the communications link, and, in response, information satisfying the request is received over the communications link.

Typically, many items of informational or promotional content will relate to or describe items or products that may be purchased. The information or display of these items or products is associated with links that take the user to commerce/purchasing layer 107. Commerce/purchasing layer provides the capability for the user to purchase the items or products that relate to the informational or promotional content.

For example, informational or promotional content layer 106 and commerce/purchasing layer 107 may be obtained by communicating over a network with a server system that dynamically generates informational or promotional content and/or commerce/purchasing content. However, if the server system or the network are not available, informational or promotional content layer 106 and commerce/purchasing layer 107 may be replaced by information that provides a way for the user to obtain more information or purchase items or products, such as a telephone number to call, an address to write to, or a Web site address to access.

Program layers 110 and 114A-C and informational or promotional content layer 106 may explicitly describe particular items or products, or these may generically describe or refer to items, their use, their advantages, etc. However, these layers may be designed to focus or lead the user to items or products that are available for purchase in commerce/purchasing layer 107. This is not mere product placement, in which a particular product is shown in a program, and then that product is available for purchase. Rather, the process provided by the present invention is one of directed, drill-down research and expanded information through one or a number of program and informational layers, eventually directing the user toward websites and commerce/purchasing layer 107, at which items or products may be purchased. This process is implemented by the use of program layers 110 and 114A-C, which include link indicators that provide the capability for the user to drill-down to explore more detailed topics directly or indirectly related to the topic in which the link indicator appears. At some point in the presentation, the display of informational or promotional content layer 106 becomes appropriate, at which point informational or promotional content layer 106 is presented. Again, the user may drill-down into one or more informational or promotional content layers, until a point is reached at which it is appropriate to display commerce/purchasing layer 107. The entire presentation may thus be designed to focus or lead the user to items or products that are available for purchase in commerce/purchasing layer 107.

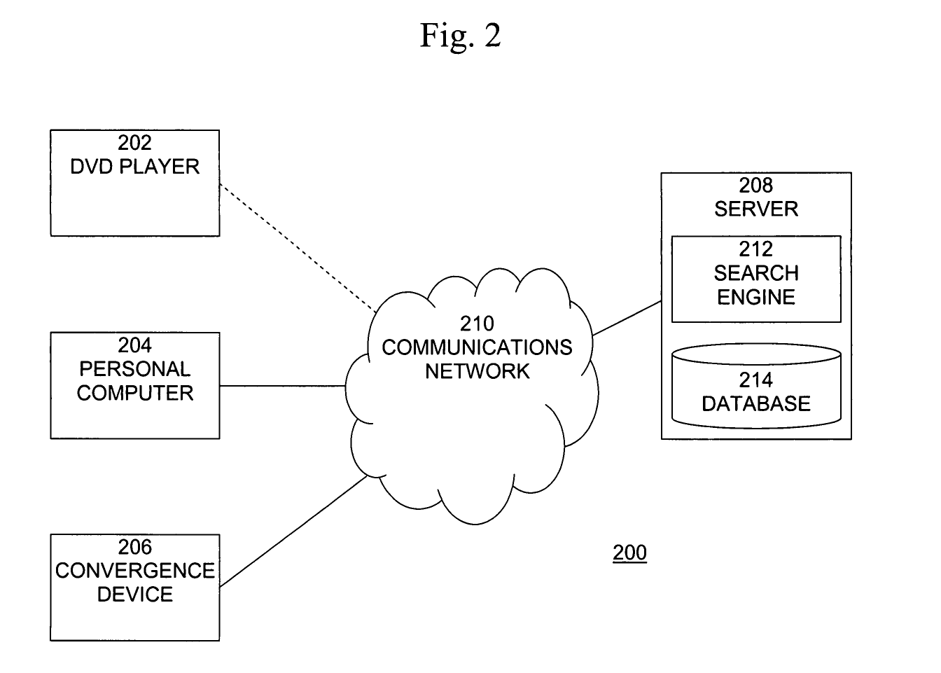

An example of a system 200, in which the present invention may be implemented, is shown in FIG. 2. System 200 includes one or more user-operated devices, such as DVD player 202, personal computer 204, convergence device 206, or other interactive display device, etc. One or more of these user-operated devices may be communicatively connected to server 208 over a communications network 210. The user-operated devices are used to display the integrated multi-layer interactive multimedia presentation to the user. For example, if the presentation is recorded on a DVD, the DVD may be inserted into any device capable of displaying a DVD, such as DVD player 202, personal computer 204, some types of convergence device 206, etc. The presentation is then displayed to the user, under control of the user, who may select link indicators as desired, in order to display the content as desired. In the case of the personal computer 204, and the convergence device 206, connection to a communications network 210 is easily achieved and all layers of content in the presentation may be displayed to the user. In the case of DVD player 202, there may not be any connection to communications network 210, in which case only the layers of content that are recorded on the DVD may be displayed.

Convergence device 206 may be any of a number of devices that have been developed or which may be developed in the future that are capable of displaying multi-media presentations and that are capable of connection to a communications network. For example, although many currently available stand-alone DVD players are not typically capable of connection to a communications network, a convergence device based on a DVD player may include a DVD player, an Internet connection, a Web browser, a display device or a connection to a display device, etc. Such a convergence device would be capable of displaying dynamic content received from server 208 over communications network 210 in addition to the content that is recorded on the DVD. Another example of a convergence device is a multi-media mobile telephone. Such a convergence device would not typically be capable of displaying DVDs, in which case the presentation may be recorded on some other type of media, such as a flash drive, etc., or the presentation may be entirely made up of dynamic content that is received from server 208 over communications network 210. Another example of a convergence device is a DVD-based video game console. Such consoles include DVD players and connections to display devices, and may include Internet connections and Web browsers. Still other examples include interactive televisions or other interactive display devices, including a display, a network connection, and an input device, such as a keyboard, and personal computers with television receiver/monitors or high-definition television receiver/monitors.

The present invention contemplates use with any and all types of convergence devices or other interactive devices that currently exist or that may be developed in the future. In addition, the present invention contemplates use with any and all types of storage media that currently exist or that may be developed in the future, or where the presentation consists entirely of dynamic content that is received from server 208 over communications network 210, no storage media.

Communications network 210 may be any type of communications network, or combination of communications networks capable of providing communications between the user-operated devices and server 208. Typically, communications network 210 includes the Internet, but may also include other public and private networks, such as the Public Switched Telephone Network, public wired or wireless telephone networks, private wired or wireless telephone networks, public wired or wireless data networks, private wired or wireless data networks etc. The present invention contemplates use with any type of communications network, or combination of communications networks capable of providing communications between the user-operated devices and one or more servers.

Server 208 includes a number of functional blocks, such as search engine 212 and database 214. Both search engine 212 and database 214 may accept a request for information received by server 208 from a user-operated device and, in response, obtain information related to the request that may be transmitted from server 208 to the user-operated device. Database 214 will use the request for information to access data stored in the database and to obtain data related to the request from the data stored in the database. Search engine 212 will use the request for information to access data that may be obtained over the Internet or Web and to obtain data related to the request from data on the Internet or Web. Other sources of information may also be used to provide information in response to a request for information from a user-operated device. The present invention contemplates the use of any currently available source of information, or any source of information that may be developed in the future.

Search engine 212 and/or database 214 may perform general-purpose searches, or search engine 212 and/or database 214 may perform focused searches based on criteria established by the operator of the search engine. For example, where the multimedia presentation relates generally to a topic, for example, cars in general, a general-purpose search may be used to return informational or promotional content relating to all makes and models of cars. Alternatively, where the multimedia presentation relates specifically to a topic, for example, a particular make and model of car, a focused search may be used to return informational or promotional content relating only to that make and model of car. Additional search criteria, such as vendors, geographic areas, etc., may also be used. The present invention contemplates the use of any search criteria that may be desired.

For example, the search criteria will include elements related to commerce or purchasing of items or products. This provides the capability to generate commerce/purchasing layer 107. Commerce/purchasing layer 107 may be generated at the same time as, or included in informational or promotional content layer 106, or commerce/purchasing layer 107 may be generated after one or more informational or promotional content layers 106 have been displayed. In either case, informational or promotional content layer 106 may be generated in such a way as to focus or direct the user to commerce/purchasing layer 107.

In addition to the above-described database and Web searches, the information included in database 214 may be organized in the form of a library, wherein the information is indexed in a number of ways for easy retrieval, organized so that requests for information will focus on desired information to lead a user to selected informational or promotional content or to perform a commerce or purchasing transaction, and presentable so as to lead a user to selected informational or promotional content or to perform a commerce or purchasing transaction. For example, the library may include a customized resource library or guide, that includes information that has been customized as desired by the operator of the server to focus the user on selected informational or promotional content or a selected commerce or purchasing transaction. Likewise, results from search engine 212 may be similarly customized, indexed, focused, and presentable so as to lead a user to perform a commerce or purchasing transaction.

The request for information from the user-operated device may take a number of forms. For example, the request may include a predefined query that is sent to search engine 212 and/or database 214, and which is used to obtain predefined or dynamic results. On the other hand, the request may include a unique link indicator identifier that may be used by server 208 to dynamically generate one or more queries that may then be used to access search engine 212 and/or database 214, and which is used to obtain dynamic results. The present invention contemplates the use of any form of request for information.

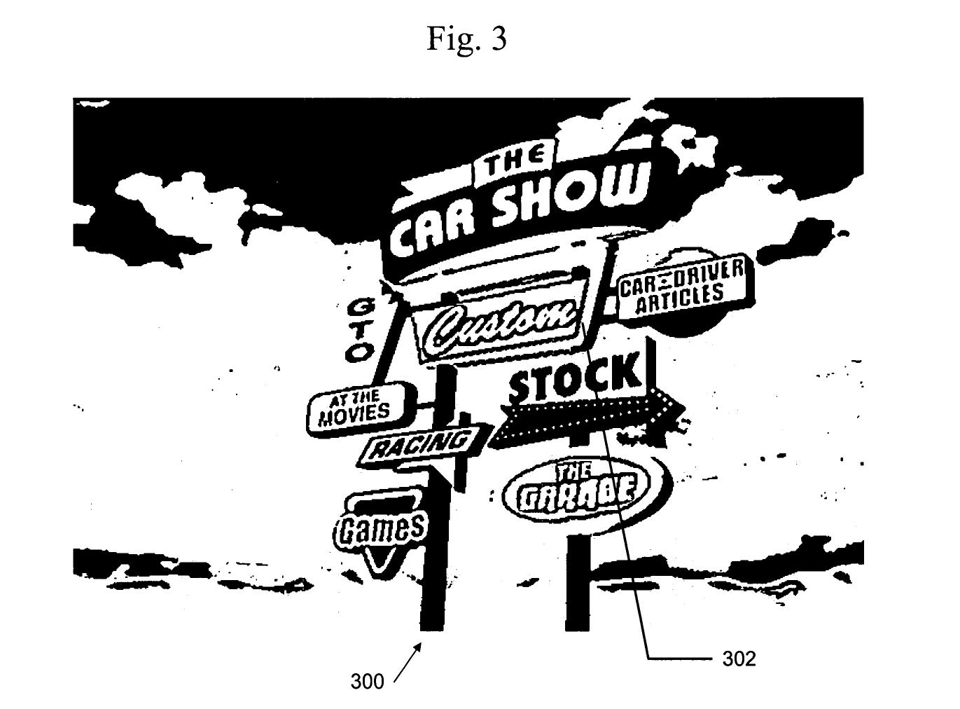

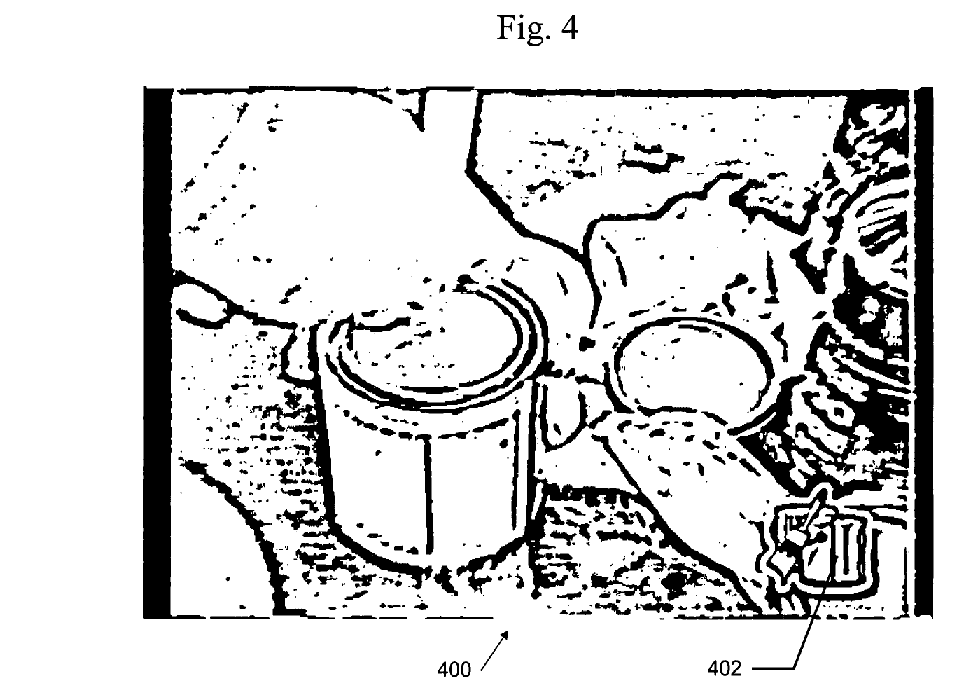

An example of a multi-layer interactive multimedia presentation according to the present invention is shown in FIGS. 3-7. This example is described in terms of a presentation including a DVD and layers of video, but is equally applicable to a presentation not including a DVD. Likewise, the particular arrangement of program layers, informational layers, commerce/purchasing layers is merely an example. The present invention contemplates and all arrangements of such layers. In this example, when a user inserts the DVD into a computer, convergence device, DVD player, or other interactive display device, a menu 300, shown in FIG. 3, appears, which provides the user with a choice of content. Using a pointing device, input device, or any device that allows selection of a link indicator, the user can select (point-and-click) their way directly to content where their interests lie. For every selection the user makes, they can “drill down” to a plurality of additional multi layers of entertainment and information with visual and print media options. For example, the user may select item 302, labeled “Custom”. In this example, selection of item 302, “Custom”, selects for display a layer including a video describing customization of cars. Among other topics in this video is a segment describing painting of cars. An exemplary screen 400 from such a segment is shown in FIG. 4. Exemplary screen 400 includes link indicator 402, which indicates that additional content directly or indirectly relating to the subject matter of the segment is available. The link indicator may be generic, or, as in this example, the link indicator may itself be customized to relate to the subject matter of the segment. For example, the segment describes the painting of cars, and the link indicator has the form of paint cans and brush.

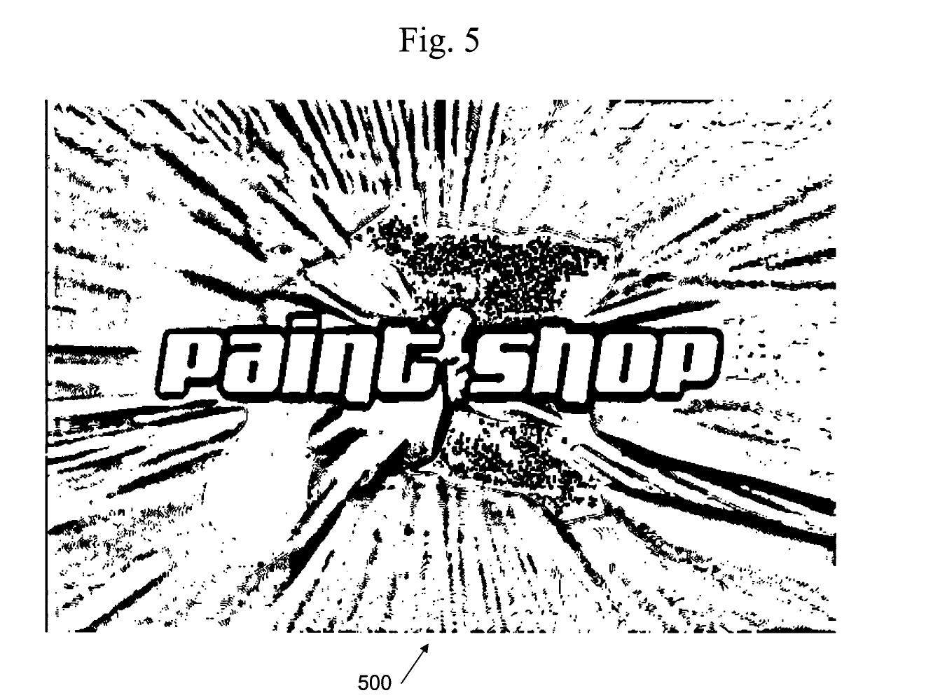

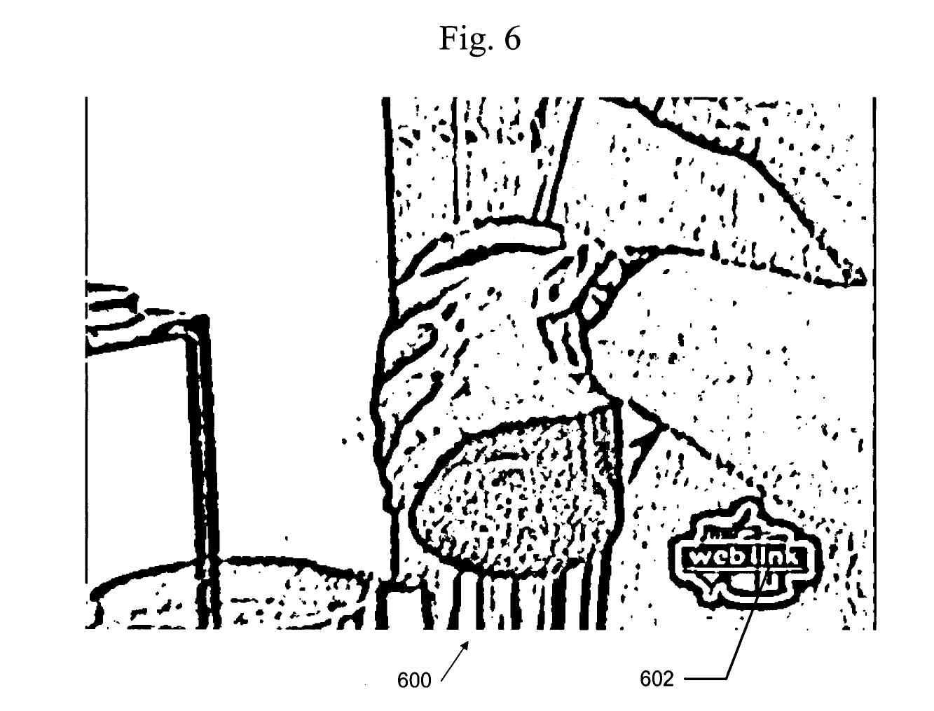

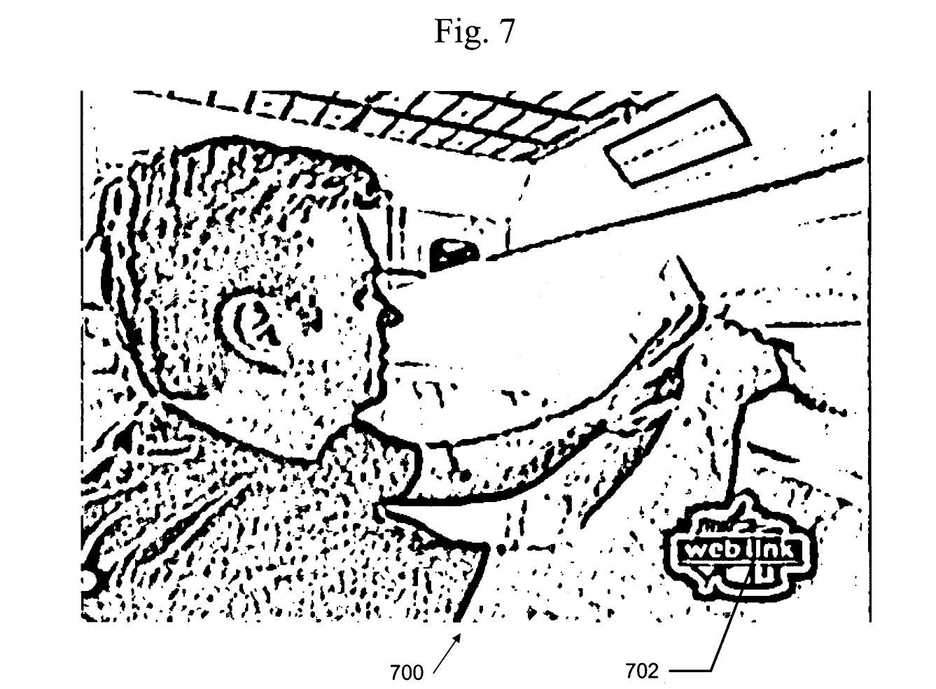

As the video is displayed to the user, link indicators are displayed during those segments of the video for which additional information is available. These link indicators may link to additional layer program content, or to informational or promotional content, which may be obtained over a communications link. The user may select any displayed link indicator, or the user may continue to watch the video. Upon selection of a link indicator, such as link indicator 402, by the user, the presentation shifts, and a new selection of an additional layer of program content, such as an additional layer video including screen 500, shown in FIG. 5, is displayed to the user. As the additional layer video is displayed to the user, link indicators are displayed during those segments of the video for which additional information is available. These link indicators may link to additional layer program content, informational or promotional content, or to commerce/purchasing content. For example, as the additional layer video continues, screen 600, shown in FIG. 6, and screen 700, shown in FIG. 7, may be displayed. Screen 600 includes link indicator 602 and screen 700 includes link indicator 702. The link indicators may be customized to relate to the subject matter of the segment, or, as in this example, they may be generic. Link indicators 602 and 702 indicate that they are Web links, which are informational or promotional content obtained from the Web. For example, the segment of the additional layer video including screen 600 relates to selection of paint, and selection of link indicator 602 will cause the display of informational or promotional content relating to the selection of paint. Likewise, the segment of the additional layer video including screen 700 relates to the selection of masking or stencil products, and selection of link indicator 702 will cause the display of informational or promotional content relating to the selection of masking or stencil products.

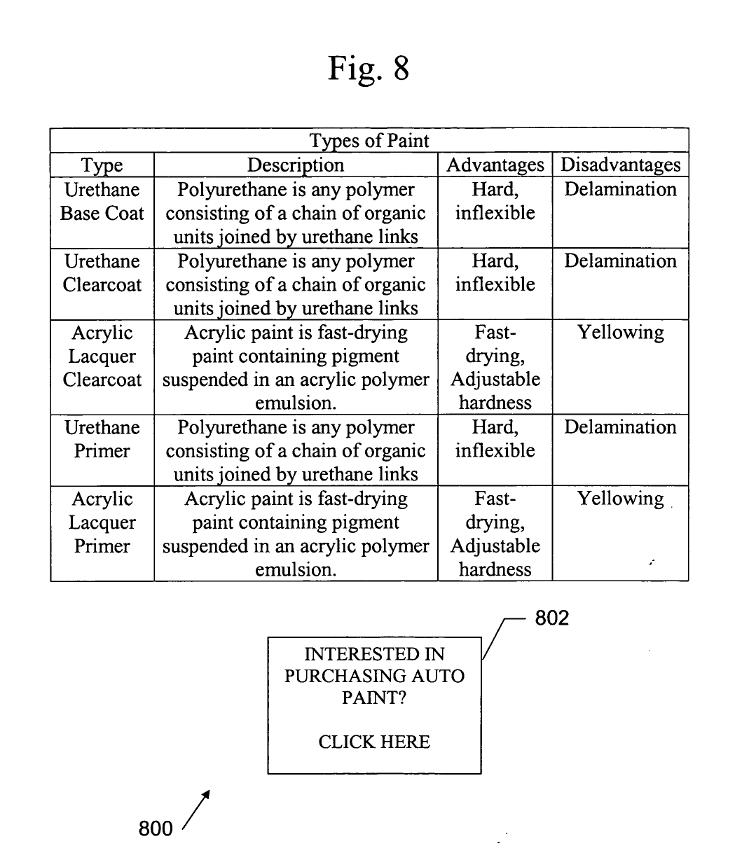

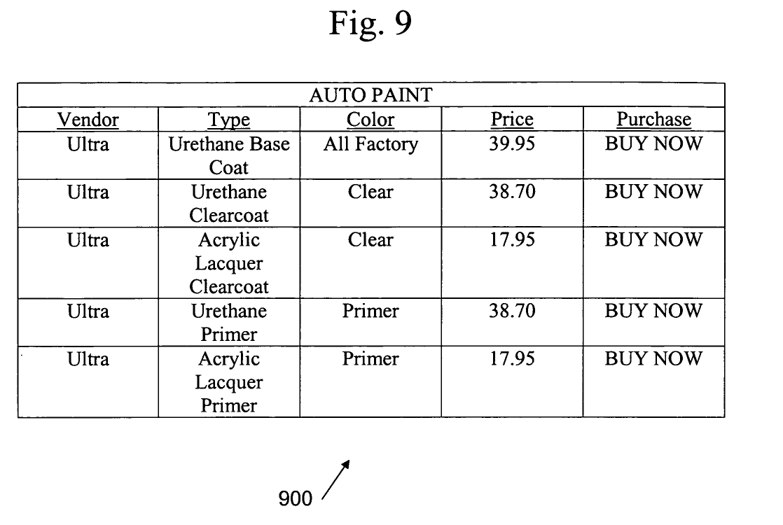

An example of display 800 of informational or promotional content that may be used by the present invention is shown in FIG. 8. Informational display 800 is an example of a display that may be generated in response to selection of a link indicator, such as link indicator 602. In this example, the segment of the additional layer video including screen 600 relates to selection of paint, and selection of link indicator 602 will cause the display of informational display 800, which provides information relating to the selection of auto paint. Display 800 includes link 802, which, when selected, causes the display of commerce/purchasing content, such as commerce/purchasing display 900, shown in FIG. 9. Selection of a link indicator on a user device, such as link indicators 602 and 802, which cause the display of informational or promotional content and/or commerce/purchasing content, cause the transmission of a request for information to a server system, such as server 208, shown in FIG. 2. The server system dynamically generates informational or promotional content and/or commerce/purchasing content in response to the request for information and transmits the generated content to the requesting user device. The user device then displays the informational or promotional content and/or commerce/purchasing content in the form of a display, such as informational display 800 or commerce/purchasing display 900.

Commerce/purchasing display 900 provides the capability for the user to purchase specific items or products that are directly or indirectly related to the information provided by the informational display 800, which caused the display of commerce/purchasing display 900.

As the user follows their interests by selecting particular link indicators, typically, at first additional program content layers are presented. The program content layers are designed to encourage the user to obtain additional information on their interests by drilling down to additional layers of content. As the user drills down into the presentation, at some point layers of informational or promotional content, which may be obtained dynamically over a communications network connection, is presented. The informational or promotional content is obtained by a special search engine or scout, which is designed to focus the user's interest on particular information directly or indirectly relating to their interests. When the user selects such content, they are launching a self-customized search for more information. This focusing eventually may lead to the presentation of commerce/purchasing content, which provides the capability for the user to purchase items or products directly or indirectly relating to their interests. These items and products are likewise selected by the special search engine or scout, based on criteria defined by the operator of the search engine.

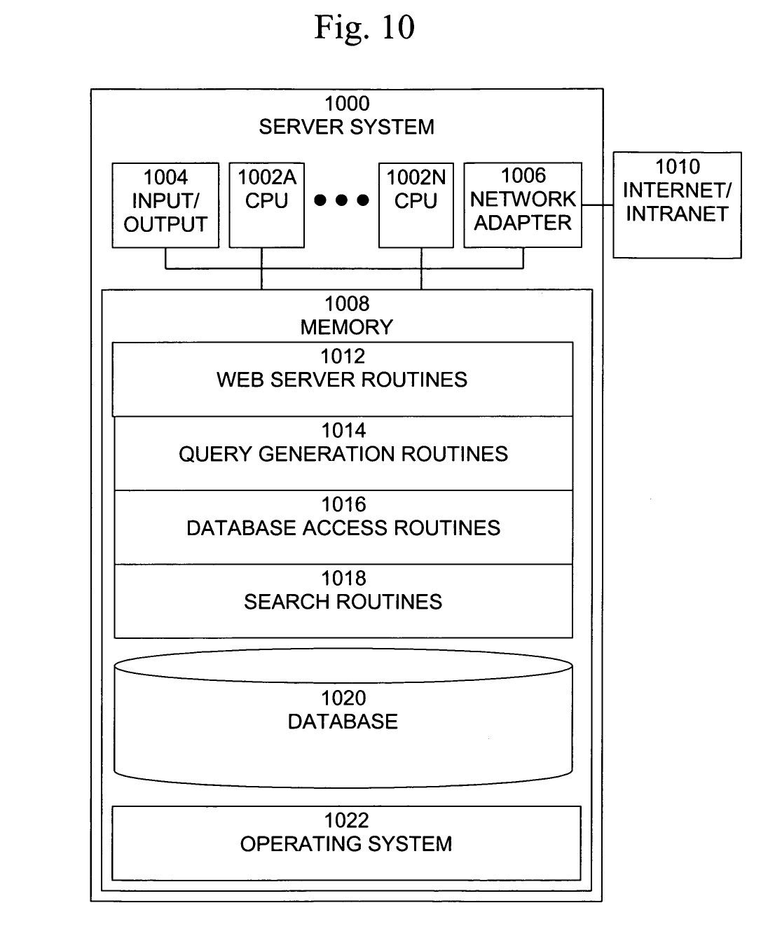

An exemplary block diagram of a server system 1000, in which the present invention may be implemented, is shown in FIG. 10. Server 1000 is typically a programmed general-purpose computer system, such as a personal computer, workstation, server system, and minicomputer or mainframe computer. Server 1000 includes one or more processors (CPUs) 1002A-1002N, input/output circuitry 1004, network adapter 1006, and memory 1008. CPUs 1002A-1002N execute program instructions in order to carry out the functions of the present invention. Typically, CPUs 1002A-1002N are one or more microprocessors, such as an INTEL PENTIUM® processor. FIG. 10 illustrates an embodiment in which server 1000 is implemented as a single multi-processor computer system, in which multiple processors 1002A-1002N share system resources, such as memory 1008, input/output circuitry 1004, and network adapter 1006. However, the present invention also contemplates embodiments in which server 1000 is implemented as a plurality of networked computer systems, which may be single-processor computer systems, multi-processor computer systems, or a mix thereof.

Input/output circuitry 1004 provides the capability to input data to, or output data from, database/server 1000. For example, input/output circuitry may include input devices, such as keyboards, mice, touchpads, trackballs, scanners, etc., output devices, such as video adapters, monitors, printers, etc., and input/output devices, such as, modems, etc. Network adapter 1006 interfaces database/server 1000 with Internet/intranet 1010. Internet/intranet 1010 may include one or more standard local area network (LAN) or wide area network (WAN), such as Ethernet, Token Ring, the Internet, or a private or proprietary LAN/WAN.

Memory 1008 stores program instructions that are executed by, and data that are used and processed by, CPU 1002 to perform the functions of server 1000. Memory 1008 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 1008 varies depending upon the functions that server 1000 is programmed to perform. One of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 10, memory 1008 includes web server routines 1012, query generation routines 1014, database access routines 1016, search routines 1018, database 1020, and operating system 1022. Web server routines 1012 receive requests for information transmitted from user-operated systems and serve up web pages based on results obtained by searching the Web or database 1020. Query generation routines 1014 generate queries to be used to search the Web or database 1020 based on the information received from user-operated systems and based on criteria established by the operator of server system 1000. Database access routines 1016 perform searches of database 1020 using queries generated by query generation routines 1014, while search routines 1018 perform searches of the Web using queries generated by query generation routines 1014. Database 1020 stores data to be used to respond to requests for information received from the user-operated systems. Operating system 1022 provides overall system functionality.

As shown in FIG. 10, the present invention contemplates implementation on a system or systems that provide multi-processor, multi-tasking, multi-process, and/or multi-thread computing, as well as implementation on systems that provide only single processor, single thread computing.

It is important to note that while the present invention has been described in the context of a fully functioning data processing system, those of ordinary skill in the art will appreciate that the processes of the present invention are capable of being distributed in the form of a computer readable storage medium of instructions and a variety of forms and that the present invention applies equally regardless of the particular type of media actually used to carry out the distribution. Examples of computer readable media include storage media such as floppy disc, hard disk drive, RAM, CD, DVD, as well as transmission media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. Apparatus for providing a multi-layer interactive multimedia presentation comprising:
means for providing a layer of program presentation, the layer of program presentation including a plurality of link indicators;
means for providing at least one additional layer of program presentation, each additional layer of program presentation including a plurality of link indicators; and
means for providing at least one display of informational or promotional content, or means for providing at least one display of commerce/purchasing content, or any combination thereof;
wherein each link indicator is operable to cause display of either an additional layer of program presentation, a display of informational or promotional content, or a display of commerce/purchasing content.

2. The apparatus of claim 1, wherein an additional layer of program presentation that is displayed upon operation of a link indicator includes subject matter directly or indirectly related to subject matter of the layer of program presentation that includes the link indicator.

3. The apparatus of claim 1, wherein informational or promotional content that is displayed upon operation of a link indicator includes subject matter directly or indirectly related to subject matter of the layer of program presentation that includes the link indicator.

4. The apparatus of claim 3, further comprising means for, upon operation of a link indicator, transmitting a request for information and receiving informational or promotional content to be displayed.

5. The apparatus of claim 1, wherein commerce/purchasing content that is displayed upon operation of a link indicator includes subject matter directly or indirectly related to subject matter of the layer of program presentation or informational or promotional content that includes the link indicator.

6. The apparatus of claim 5, further comprising means for, upon operation of a link indicator, transmitting a request for information and receiving commerce/purchasing content to be displayed.

7. The apparatus of claim 6, wherein the informational or promotional content, the commerce/purchasing content, or both, is obtained using a customized resource library or guide, including information that has been customized to focus a user on selected informational or promotional content or a selected commerce or purchasing transaction.

8. The apparatus of claim 1, wherein the layer of program presentation and at least some of the plurality of additional layers of program presentation are stored on a computer readable storage medium possessed by a user of the apparatus.

9. The apparatus of claim 8, wherein the informational or promotional content and the commerce/purchasing content is obtained over the Internet or Web.

10. The apparatus of claim 8, wherein the computer readable storage medium is a DVD.

11. The apparatus of claim 1, wherein the layer of program presentation, the plurality of additional layers of program presentation, the informational or promotional content, and the commerce/purchasing content are obtained over the Internet or Web.

12. The apparatus of claim 1, wherein at least a portion of the link indicators are customized to relate to the subject matter of a program presentation in which each link indicator is included.

13. The apparatus of claim 1, wherein the apparatus comprises a DVD player, a network-connected DVD player, a personal computer, a network-connected personal computer, a personal computer with a television receiver/monitor, a personal computer with a high-definition television receiver/monitor, a network-connected personal computer with a television receiver/monitor, a network-connected personal computer with a high-definition television receiver/monitor, a convergence device, an interactive display device, a multimedia telephone, an interactive television, or any combination thereof.

14. A computer-implemented method of providing a multi-layer interactive multimedia presentation comprising:
displaying one of a layer of program presentation or one of a plurality of additional layers of program presentation, the layer of program presentation including a plurality of link indicators, and each additional layer of program presentation including a plurality of link indicators; and
accepting operation of one of the plurality of link indicators included in the layer of program presentation and in response displaying an additional layer of program presentation, displaying informational or promotional content, or displaying commerce/purchasing content.

15. The method of claim 14, wherein an additional layer of program presentation that is displayed upon operation of a link indicator includes subject matter directly or indirectly related to subject matter of the layer of program presentation that includes the link indicator.

16. The method of claim 14, wherein informational or promotional content that is displayed upon operation of a link indicator includes subject matter directly or indirectly related to subject matter of the layer of program presentation that includes the link indicator.

17. The method of claim 16, further comprising upon accepting operation of a link indicator, transmitting a request for information and receiving informational or promotional content to be displayed.

18. The apparatus of claim 17, wherein the informational or promotional content, the commerce/purchasing content, or both, is obtained using a customized resource library or guide, including information that has been customized to focus a user on selected informational or promotional content or a selected commerce or purchasing transaction.

19. The apparatus of claim 14, wherein commerce/purchasing content that is displayed upon operation of a link indicator includes subject matter directly or indirectly related to subject matter of the layer of program presentation or informational or promotional content that includes the link indicator.

20. The apparatus of claim 19, further comprising upon operation of a link indicator, transmitting a request for information and receiving commerce/purchasing content to be displayed.

21. The method of claim 14, wherein the layer of program presentation and at least some of the plurality of additional layers of program presentation are stored on a computer readable storage medium possessed by a user of the apparatus.

22. The method of claim 21, wherein the informational or promotional content and the commerce/purchasing content is obtained over the Internet or Web.

23. The method of claim 21, wherein the computer readable storage medium is a DVD.

24. The method of claim 14, wherein the layer of program presentation, the plurality of additional layers of program presentation, the informational or promotional content, and the commerce/purchasing content are obtained over the Internet or Web.

25. The method of claim 14, wherein at least a portion of the link indicators are customized to relate to the subject matter of a program presentation in which each link indicator is included.

26. The method of claim 14, wherein the method is performed using a DVD player, a network-connected DVD player, a personal computer, a network-connected personal computer, a personal computer with a television receiver/monitor, a personal computer with a high-definition television receiver/monitor, a network-connected personal computer with a television receiver/monitor, a network-connected personal computer with a high-definition television receiver/monitor, a convergence device, an interactive display device, a multimedia telephone, an interactive television, or any combination thereof.

27. A method of providing marketing and conducting commerce comprising:
providing a layer of program presentation relating to a general topic, the layer of program presentation including a plurality of link indicators, each link indicator relating to a segment of the layer of program presentation;
providing at least one additional layer of program presentation, each additional layer of program presentation including a plurality of link indicators, each additional layer of program presentation providing additional information directly or indirectly relating to a segment of the layer of program presentation or another additional layer of program presentation that includes a link indicator that causes display of the additional layer of program presentation; and
providing at least one display of informational or promotional content or at least one display of commerce/purchasing content, each display of informational or promotional content or of commerce/purchasing content directly or indirectly relating to a segment of the layer of program presentation, an additional layer of program presentation, or another display of informational or promotional content or commerce/purchasing content that includes a link indicator that causes display of the informational or promotional content or the commerce/purchasing content;
wherein the display of the layer of program information, the additional layers of program presentation, the display of informational or promotional content, and the display of commerce/purchasing content direct a user toward additional informational or promotional content or toward performing a commerce/purchasing transaction.

28. The method of claim 27, wherein an additional layer of program presentation that is displayed upon operation of a link indicator includes subject matter directly or indirectly related to subject matter of the layer of program presentation that includes the link indicator.

29. The method of claim 27, wherein informational or promotional content that is displayed upon operation of a link indicator includes subject matter directly or indirectly related to subject matter of the layer of program presentation that includes the link indicator.

30. The method of claim 29, further comprising upon accepting operation of a link indicator, transmitting a request for information and receiving informational or promotional content to be displayed.

31. The apparatus of claim 27, wherein commerce/purchasing content that is displayed upon operation of a link indicator includes subject matter directly or indirectly related to subject matter of the layer of program presentation or informational or promotional content that includes the link indicator.

32. The apparatus of claim 31, further comprising upon operation of a link indicator, transmitting a request for information and receiving commerce/purchasing content to be displayed.

33. The apparatus of claim 32, wherein the informational or promotional content, the commerce/purchasing content, or both, is obtained using a customized resource library or guide, including information that has been customized to focus a user on selected informational or promotional content or a selected commerce or purchasing transaction.

34. The method of claim 27, wherein the layer of program presentation and at least some of the plurality of additional layers of program presentation are stored on a computer readable storage medium possessed by a user of the apparatus.

35. The method of claim 34, wherein the informational or promotional content and the commerce/purchasing content is obtained over the Internet or Web.

36. The method of claim 34, wherein the computer readable storage medium is a DVD.

37. The method of claim 27, wherein the layer of program presentation, the plurality of additional layers of program presentation, the informational or promotional content, and the commerce/purchasing content are obtained over the Internet or Web.

38. The method of claim 27, wherein at least a portion of the link indicators are customized to relate to the subject matter of a program presentation in which each link indicator is included.

39. The method of claim 27, wherein the method is performed using a DVD player, a network-connected DVD player, a personal computer, a network-connected personal computer, a personal computer with a television receiver/monitor, a personal computer with a high-definition television receiver/monitor, a network-connected personal computer with a television receiver/monitor, a network-connected personal computer with a high-definition television receiver/monitor, a convergence device, an interactive display device, a multimedia telephone, an interactive television, or any combination thereof.
